(19) United States
(12) Patent Application Publication
(10) Pub. No.: US 2007/0056647 A1
(43) Pub. Date: Mar. 15, 2007

(54) Flexible valves

(75) Inventor: Shawn Frayne, San Francisco, CA (US)

Correspondence Address: Sealed Air Corporation, P.O. Box 464, Duncan, SC, 29334, US

(73) Assignee: Sealed Air Corporation (US)

(21) Appl. No.: 11/516,472

(22) Filed: Sep. 6, 2006

Related U.S. Application Data
(60) Provisional application No. 60/716,292, filed on Sep. 12, 2005.

(51) Int. Cl. F16K 15/14

(52) U.S. Cl. 137/843

(57) ABSTRACT

A flexible valve includes two or more juxtaposed film plies joined together with one or more seals. The valve is movable between (1) an ingress position to allow fluid flow through the valve in a first direction, e.g., into a container with which the valve is associated; (2) a seal position to substantially prevent fluid flow through the valve; and (3) an egress position to allow fluid flow through the valve in a second direction, e.g., out of a container with which the valve is associated.

This Application claims the benefit of U.S. Provisional Application No. 60/716,292, filed Sep. 12, 2005, the disclosure of which is hereby incorporated herein by reference thereto.

### BACKGROUND OF THE INVENTION

The present invention relates to flexible, generally flat valve structures. More particularly, the present invention relates to flexible valves that contain an egress mechanism, which allows containers with which such valves are associated to be emptied of fluid contained therein.

Simple and inexpensive flexible valves are well-known in the art. Such valves are generally constructed from two or more flexible films that are juxtaposed and sealed together to form a structure having a flat profile and an internal fluid-passage channel through which fluids may flow. Such valves are typically one-way, self-self sealing valves, which allow fluid flow in one direction but substantially prevent fluid flow in the opposite direction. In use, the valves are typically incorporated into containers, generally flexible containers, to provide an ingress port through which fluids may be injected into the container. The most common examples of such containers include inflatable articles such as balloons, toys, and dunnage cushions. Dunnage cushions are inflatable containers placed in shipping cartons between the walls of the carton and the product to be shipped to thereby protect the product during shipment. Another example of a container with which flexible valves could be used is a liquid-containing article, such as a water-containment bag.

Conventional flexible valves typically operate by including an ingress channel that extends into the container and is formed by two juxtaposed film plies. Once the container has been filled, e.g., inflated, the internal pressure within the container will generally be higher than atmospheric pressure. This elevated pressure pushes the two plies of the ingress channel together, thereby sealing the channel closed and thus preventing the outflow of fluid from the container.

One drawback associated with conventional flexible valves concerns the manner in which containers incorporating such valves may be deflated or emptied. Typically, in order to empty a container with which such a valve is associated, the ingress channel must be braced open with a foreign object, such as a straw or rod, to allow for the escape of whatever gas or liquid the valve had been confining within the container. Such a technique can damage the internal components of the valve, which are generally formed of relatively thin flexible films, thereby promoting leakage in any subsequent re-use of the container with which the valve is associated. Moreover, the need to locate a suitable foreign object into the valve is time consuming, and can lead to undesired delays in high-speed packaging situations.

Accordingly, a need exists in the art for an improved flexible valve having an egress mechanism.

### SUMMARY OF THE INVENTION

That need is met by the present invention, which, in one aspect, provides a flexible valve, comprising two or more juxtaposed film plies joined together with one or more seals, wherein the valve is movable between:

a. an ingress position to allow fluid flow through the valve in a first direction, e.g., into a container with which the valve is associated;

b. a seal position to substantially prevent fluid flow through the valve; and

c. an egress position to allow fluid flow through the valve in a second direction, e.g., out of a container with which the valve is associated.

Advantageously, when the valve is in the egress position, the valve is capable of maintaining itself in an opened configuration to allow fluid flow in the second direction, e.g., out of a container, without the need for external manipulation of the valve.

Another aspect of the invention is directed towards a container comprising a container housing and the foregoing flexible valve, which is in fluid communication with, e.g., incorporated into, the container housing.

A further aspect of the present invention pertains to a flexible valve, comprising two or more juxtaposed film plies joined together with one or more seals, the valve comprising:

a. an ingress channel, which allows fluid flow in a first direction through the ingress channel but substantially prevents fluid flow in a second direction through the ingress channel; and

b. an egress channel, which is movable between:
(1) a seal position to substantially prevent fluid flow through the egress channel, and
(2) an egress position to allow fluid flow through the egress channel.

An additional aspect of the invention relates to a container comprising a container housing and the foregoing flexible valve, which is in fluid communication with the container housing.

These and other aspects and features of the invention may be better understood with reference to the following description and accompanying drawings.

### BRIEF DESCRIPTION OF THE DRAWINGS

FIG. 1 is a plan view of a flexible, self-closing valve structure of the prior art;

FIG. 2 is a plan view one embodiment of a flexible valve in accordance with the present invention;

FIG. 3A is a perspective view showing the valve of FIG. 2 incorporated into a container, e.g., an inflatable cushion, wherein the valve is in the ingress position and receiving fluid from a fluid injection device;

FIG. 3B is similar to FIG. 3A, except that the valve is in the seal position, resulting in no fluid flow through the valve;

FIG. 3C is similar to FIG. 3A, except that the valve is in the egress position, allowing fluid to flow out of the container;

FIG. 4A is a plan view of the three components comprising the valve structure depicted in assembled form in FIG. 2;

FIG. 4B is a plan view of two of the components shown in FIG. 4A sealed together;

FIG. 4C is a plan view of all three of the components shown in FIG. 4A sealed together;

FIG. 5 is a plan view of another embodiment of a flexible valve in accordance with the present invention;

FIG. 6A is a perspective view showing the valve of FIG. 5 incorporated into a container, wherein the valve is in the ingress position and receiving fluid from a fluid injection device;

FIG. 6B is a perspective view of the valve of FIG. 5, showing the neck being folded into the body;

FIG. 6C is similar to FIG. 6A, except that the valve is in the seal position, resulting in no fluid flow through the valve;

FIG. 6D is similar to FIG. 6A, except that the valve is in the egress position, allowing fluid to flow out of the container;

FIG. 7A is a plan view of another embodiment of a flexible valve in accordance with the present invention, which includes an entry collar;

FIG. 7B is a partial plan view showing the valve FIG. 7A incorporated into a container;

FIG. 8 is a plan view of yet another embodiment of a flexible valve in accordance with the present invention, which includes multiple diverging ingress channels;

FIG. 9 is a partial plan view of the valve structure of FIG. 5 incorporated into an inflatable structure with a neck, such as a balloon;

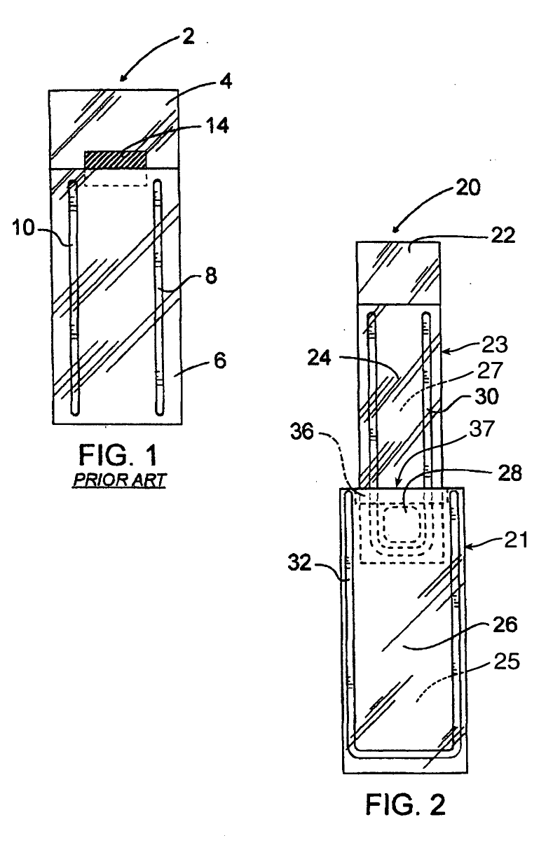

FIG. 1OA is a plan view of a further embodiment of a flexible valve in accordance with the present invention, which includes a tapered egress channel;

FIG. 10B is a plan view of the separate components of the valve shown in FIG. 1OA;

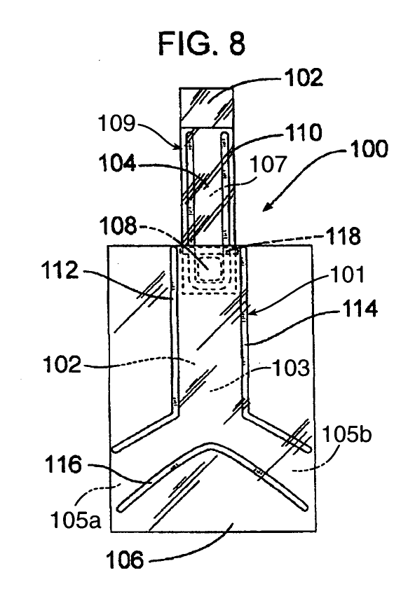

FIG. 11A is a schematic of a manufacturing operation for producing the valve shown in FIG. 5;

FIG. 11B is a plan view of the separate webs of film used in the manufacturing process depicted in FIG. 11A;

FIG. 11C is a plan view of the separate webs of film illustrated in FIG. 11B superimposed on one another into a resultant web of film, as is the case during a particular step of the manufacturing process depicted in FIG. 11A;

FIG. 11D is a plan view of the layered web of film in FIG. 11C, heat sealed along particular weld lines;

FIG. 11E is a plan view of the heat sealed web of film depicted in FIG. 11D following a cutting operation that results in the completion of the manufacturing operation depicted in FIG. 11A;

FIG. 12A is a plan view of another embodiment of a flexible valve in accordance with the present invention, which includes a modified egress channel;

FIG. 12B is a perspective view of the valve shown in FIG. 12A, wherein fluid is flowing through the ingress channel;

FIG. 12C is a perspective view of the valve shown in FIG. 12A, wherein fluid is flowing through the egress channel;

FIG. 12D is a plan view of the separate components of the valve shown in FIG. 12A; and

FIGS. 13A-C are plan views of a manufacturing process for the valve shown in FIG. 12A.

### DETAILED DESCRIPTION OF THE INVENTION

With reference to FIG. 1, there is pictured a flexible, self-sealing valve of the prior art designated generally by the reference numeral 2. The self-sealing valve in this figure is comprised of a first film ply of thermoplastic material 4 and a second film ply of thermoplastic material 6 entirely parallel and coplanar with each other. The first and the second film plies 4, 6 are secured together at weld lines 8, 10 along the longitudinal sides of the film plies and together define a channel. A heat resistant coating 14 is also pictured, applied to film ply 4. The heat resistant coating prevents the accidental closure of the channel when the valve is incorporated into an article by heat sealing means.

The operation of this flexible, flat valve of the prior art involves the injection of a gas, usually air, through the channel defined by film plies 4, 6 and welds 8, 10 into an article (not-pictured) to be inflated. Once the article is partially or wholly inflated, internal gas pressure will force the two film plies 4, 6 together. This has the effect of preventing any fluid flow from the inside of the inflated article through the channel, thereby effecting an automatic seal of the article. However, there is no mechanism incorporated into this valve that would allow the inflated article to be deflated. To deflate the article incorporating a valve such as that depicted in FIG. 1, the channel must be propped open through the insertion of a foreign object, such as a straw or rod. Gas may then escape through the straw or around the edges of the rod, and the article can be deflated. Most valves of the prior art operate in this manner regardless of their numerous design variations.

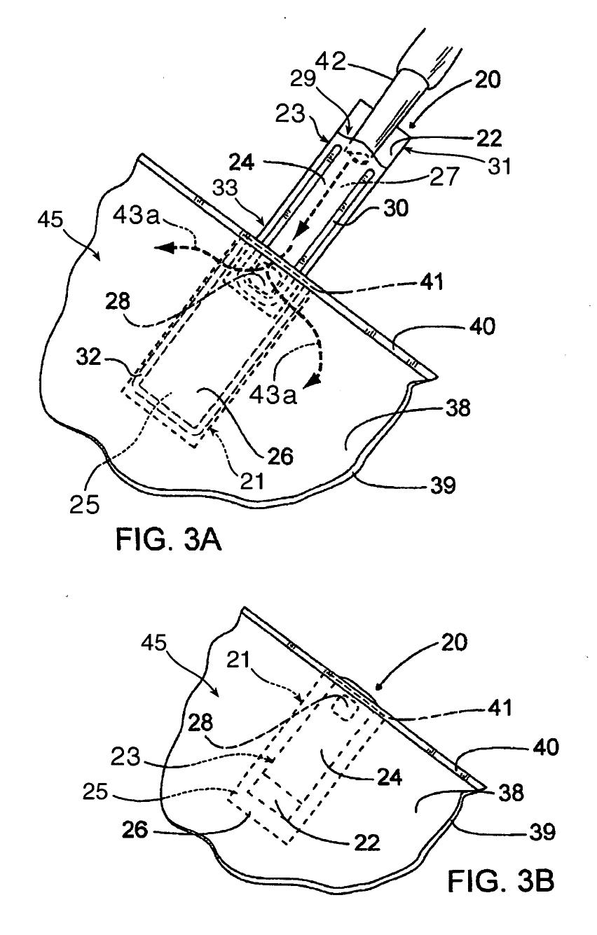

With general reference to FIGS. 2-4, one aspect of the present invention pertains to a flexible valve 20, comprising two or more juxtaposed film plies 22, 24, 26 joined together with one or more seals 30, 32. Valve 20 is movable between:

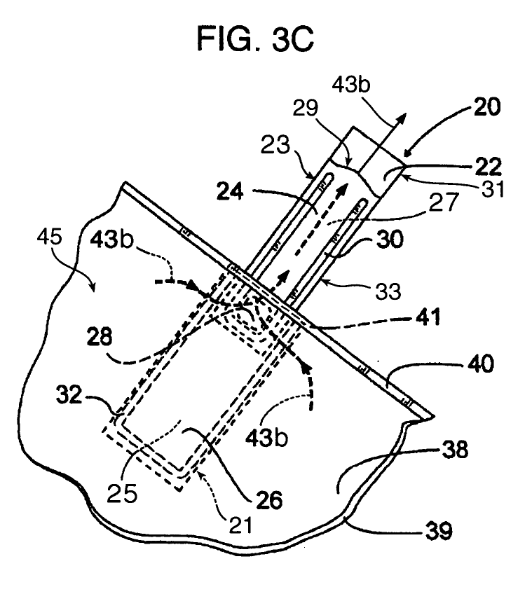

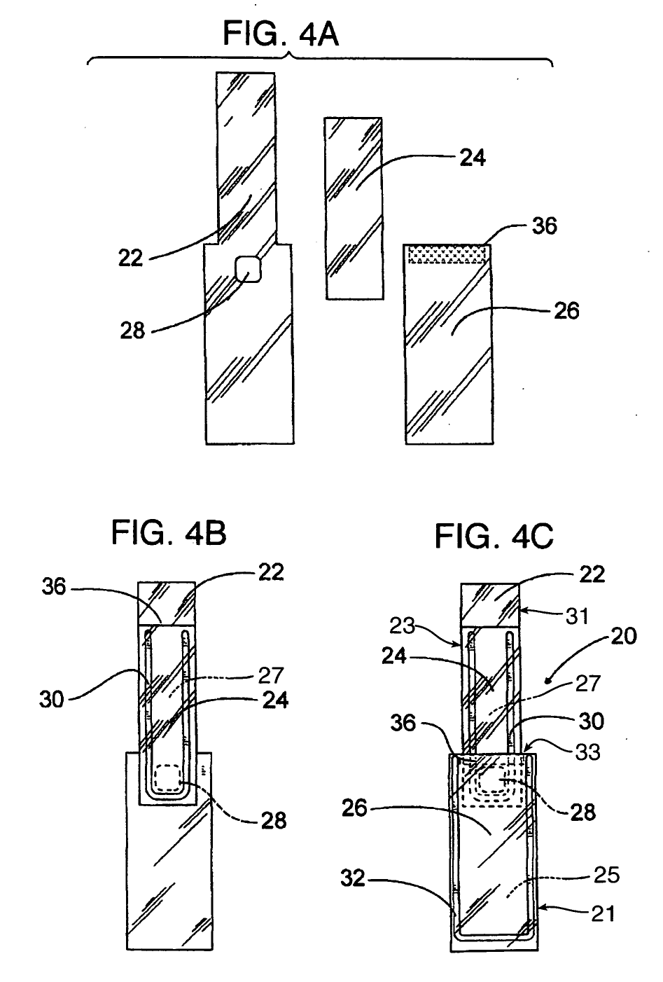

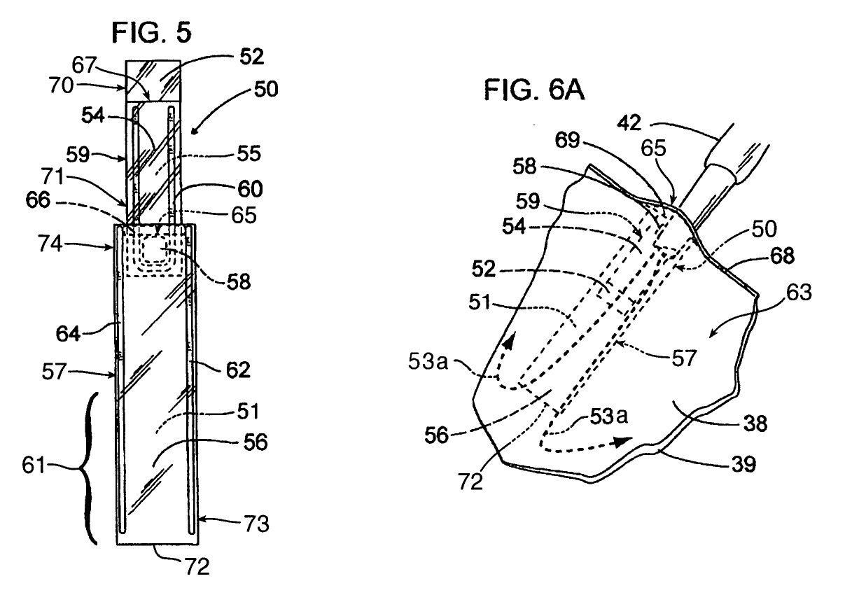

a. an ingress position (FIG. 3A) to allow fluid flow through the valve in a first direction 43a;

b. a seal position (FIG. 3B) to substantially prevent fluid flow through the valve; and

c. an egress position (FIG. 3C) to allow fluid flow through the valve in a second direction 43b.

The design of valve 20 is such that, when in the egress position shown in FIG. 3C, the valve is capable of maintaining itself in an opened configuration to allow fluid flow in second direction 43b without the need for external manipulation of the valve. In this manner, valve 20 can release fluid from a container with which the valve is associated without the necessity of being propped open, e.g., with an external object such as a rod or straw, as is typically required of conventional valves.

Each component of the flexible valve 20, including film plies 22, 24, 26, may comprise any flexible material that can enclose a fluid as herein described, including various thermoplastic materials, e.g., polyethylene homopolymer or copolymer, polypropylene homopolymer or copolymer, etc. Non-limiting examples of suitable thermoplastic polymers include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, such as 1-butene, 1-pentene, 1-hexene, 1-octene, methyl pentene and the like, in which the polymer molecules comprise long chains with relatively few side chain branches, including linear low density polyethylene (LLDPE), linear medium density polyethylene (LMDPE), very low density polyethylene (VLDPE), and ultra-low density polyethylene (ULDPE). Various other materials are also suitable such as, e.g., polypropylene homopolymer or polypropylene copolymer (e.g., propylene/ethylene copolymer), polyesters, polystyrenes, polyamides, polycarbonates, etc. The film may be monolayer or multilayer and can be made by any known coextrusion process by melting the component polymer(s) and extruding or coextruding them through one or more flat or annular dies. Composite, e.g., multilayered, materials may be employed to provide a variety of additional characteristics such as durability, enhanced gas-barrier functionality, etc.

The seals that join the film plies together can be any conventional and/or appropriate type of seal, including heat-welds, adhesive bonds, cohesive bonds, etc., including combinations of the foregoing.

As used herein, the term “flexible” refers to materials, and valves comprising such materials, that are pliant and capable of undergoing a large variety of changes in shape, e.g., bending, creasing, folding, rolling, crumpling, etc., with substantially no damage thereto in response to the action of an applied force; flexible materials are also capable of substantially returning to their general original shape when the applied force is removed. Flexible valves are thus distinguishable from rigid valves, which contain inflexible components that are generally capable of moving only along a limited, pre-determined path, e.g., tubular valves used for automobile and bicycle tires.

As shown, flexible valve 20 may include a body 21 and a neck 23 affixed to the body. Neck 23 may be movable relative to body 21. For example, when valve 20 is in the ingress (FIG. 3A) or egress (FIG. 3C) positions, neck 23 is extended outwards from body 21. In contrast, when valve 20 is in the seal position (FIG. 3B), neck 23 is at least partially contained within body 21, e.g., by being folded such that at least a segment thereof is contained within the body as shown.

As also shown, body 21 may include a body channel 25; similarly, neck 23 may include a neck channel 27. Each of the channels 25, 27 may be formed between two film plies, as will be described below in further detail.

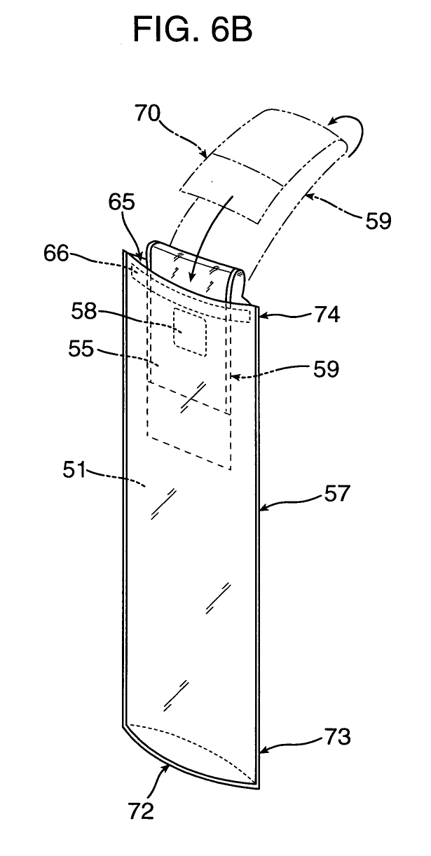

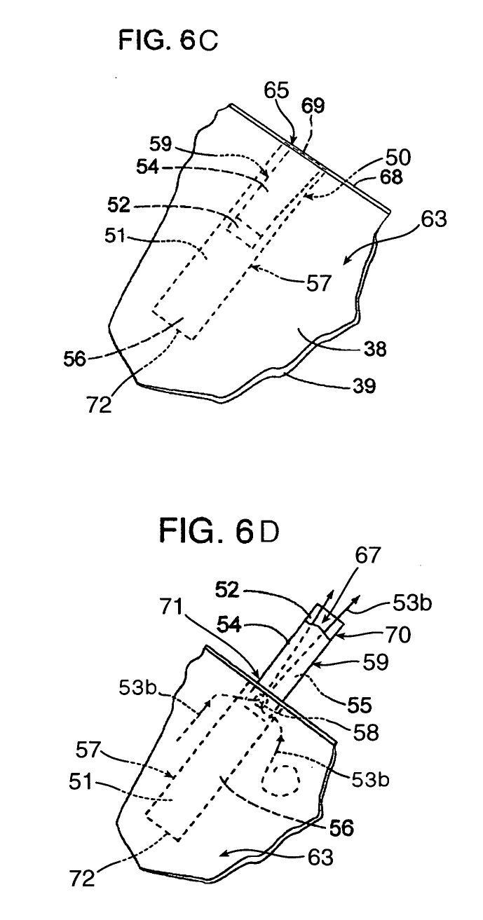

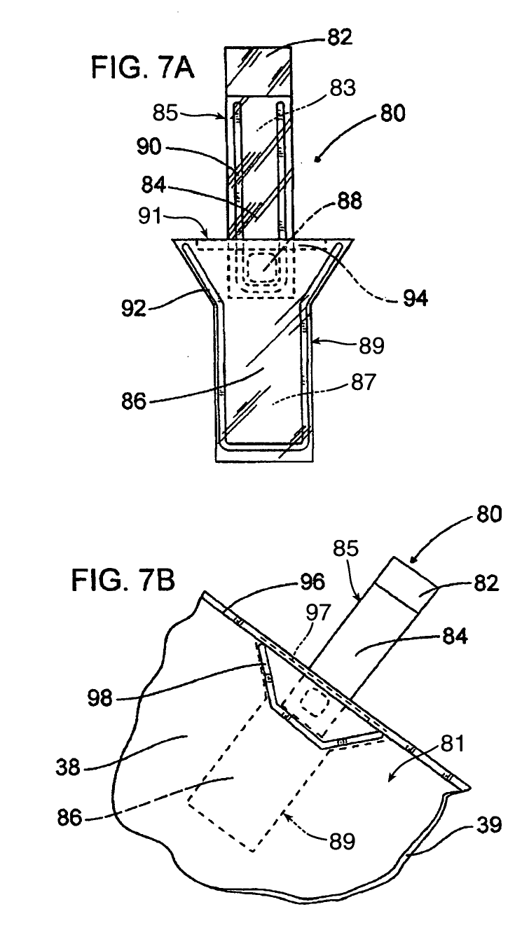

As noted above, valve 20 may be constructed of two or more juxtaposed film plies, which, in this embodiment, comprise three film plies 22, 24, 26 of thermoplastic film material. FIG. 4A depicts these film plies separately. Each has been preconfigured, e.g., cut, into a desired shape prior to assembly into valve 20. Film ply 22 may include a hole 28, which may be rectangular in shape as shown, or have any other desired shape, e.g., round, diamond, triangular, etc. Additionally, the underside of film ply 26 may be imprinted with a heat resistant coating 36.

FIG. 4B shows a first step in the assembly of the valve 20. A U-shaped weld line 30 may be used to join film ply 22 to film ply 24, the latter being sealed on top of the former as pictured. The weld 30 defines neck channel 27 between the two film plies 22, 24 as shown.

In FIG. 4C, film ply 26 is joined to the top of film ply 22 with another U-shaped weld line 32. The weld 32 defines body channel 25 between the film plies 22, 26 as shown, and also between film plies 24, 26 (near orifice 28).

The completed valve 20 may be incorporated into or otherwise associated with an appropriate container, such as, e.g., a balloon, dunnage bag, or liquid bladder. Such incorporation is shown in FIG. 3A, wherein valve 20 is placed in between two aligned film plies of thermoplastic material 38, 39 of container 45, the latter being beneath the former as pictured. These two film plies define a housing for container 45, whether it be a balloon, dunnage bag, flexible packaging container, e.g., for food, or any other number of inflatable (gas-containing) or liquid-containing articles, inasmuch as flexible valves in accordance with the present invention may be used with liquid or gaseous fluids. The container film plies 38, 39 may be joined to one another through a weld line 40. This heat seal weld also joins the top film ply 38 to the valve component film ply 26. Another weld line 41 may be made between film ply 39 and valve component film ply 22, the weld 41 being applied to the underside of the article as pictured. Two weld lines thus applied, either concurrently or in succession, will secure the valve structure 20 hermetically within the container 45 and allow valve 20 to fluidly communicate with the interior of the container.

Heat resistant coating 36 (unpictured in FIG. 3A) may be included to prevent undesired joining of film ply 26 to film ply 24 during the application of weld 40, in order to maintain an opening 37 therebetween (FIG. 2). Opening 37 allows access to body channel 25, for reasons that will be explained below. If desired, e.g., due to heat sealing temperature variability, an additional heat resistant coating can be applied around hole 28 on film ply 22 and/or above hole 28 on film ply 24 to prevent the inadvertent closure of such orifice. The application of heat resistant coatings to prevent undesired sealing of thermoplastic films is a technique well-known in the art.

Accordingly, when constructed in accordance with the foregoing, valve 20 may be understood to include a first orifice 29 located at a distal region 31 of neck 23, wherein first orifice 29 is in fluid communication with neck channel 27. Valve 20 may further include a second orifice formed by hole 28 (henceforth termed “second orifice 28”), which may be located at a proximal region 33 of neck 23 and which is also in fluid communication with neck channel 27. As shown, the proximal region 33 of neck 23 is the general region of valve 20 at which the neck is affixed to body 21; the distal region 31 is the general region of neck 23 that extends outwardly from the proximal region 33.

Referring specifically to FIG. 3A, it may be seen that first orifice 29 may be adapted to receive a fluid injection device 42 when valve 20 is in the ingress position as shown, to thereby cause fluid flow in first direction 43a. Fluid flowing in first direction 43a may thus flow into valve 20 via first orifice 29, through neck channel 27, and out of valve 20 via second orifice 28 when the valve is in the ingress position as shown in FIG. 3A. The fluid 43a may then flow into the interior of the container 45 as shown, thereby filling such container to a desired extent.

Fluid injection device 42 may be any conventional device used to direct flowing fluid in a desired manner, e.g., a nozzle or the like, through which various gasses may flow, e.g., air, helium, nitrogen, carbon dioxide, oxygen, etc., or through which various liquids may flow, e.g., water, flowable foods (ketchup, soup, sauces, syrup, etc.), industrial solutions, etc., depending upon the end-use application for container 45.

Once the injection device 42 is removed from the first orifice 29, fluid is free to escape from container 45. This is because there is only atmospheric pressure acting on neck 23 and neck channel 27; in contrast, the pressure inside of container 45 will generally be greater than atmospheric; fluid flow may thus proceed unimpeded from the container. Such outflow may be prevented (at least until such outflow is desired) by moving the neck 23 such that valve 20 assumes the seal position shown in FIG. 3B. This may be accomplished by folding the neck 23 and inserting the distal region 31 thereof into body channel 25 via opening 37. As explained above, access to body channel 25 is provided by the unsealed opening 37. Since the formerly exterior neck 23 of valve 20 is consequently almost entirely housed within the filled, e.g., inflated, container 45 (albeit in body channel 25), it can be acted upon by the elevated fluid pressure within the container (assuming a sufficient amount of fluid 43a was introduced into the container to elevate the internal pressure thereof). In other words, the same pressure that acts to force together the body channel 25 between film plies 22 and 26 will also act on the walls 22, 24 of neck 23, and thereby seal closed the neck channel 27. In addition to preventing, or at least greatly reducing, fluid flow through neck channel 27, this pressure will also serve to maintain neck 23 within body channel 25 while valve 20 is in the seal position shown in FIG. 3B. Since the fluid-flow passage provided by the first and second orifices 29, 28 and neck channel 27 is the only passage that exists between the interior of container 45 and the ambient environment (assuming no other holes or valves associated with such container), the seal position assumed by valve 20 effectively seals the fluid within the container.

When it is desired to expel or otherwise remove fluid from container 45, valve 20 may be moved to the egress position shown in FIG. 3C. This may be accomplished, as shown, by removing neck 23 from body channel 25, i.e., by unfolding the neck and placing it in or allowing it to assume the extended/unfurled configuration shown in FIG. 3C. In this manner, fluid from within container 45 may flow in second direction 43b by flowing into valve 20 via second orifice 28, through neck channel 27, and out of valve 20 via first orifice 29 when the valve is in the egress position depicted in FIG. 3C. In such position, which is similar to the ingress position shown in FIG. 3A, only atmospheric pressure acts on neck 23 and, therefore, neck channel 27. In contrast, the pressure inside of container 45 will generally be greater than atmospheric, depending, e.g., on the amount of fluid injected into the container. Further, neck 23 with neck channel 27 therein, is capable of self-support as shown. Fluid flow 43b may thus proceed unimpeded from the container via first and second orifices 29, 28 and neck channel 27 when valve 20 is in the egress position, without the need for external manipulation of the valve to maintain such an opened configuration for fluid flow out of the container. In this manner, unlike conventional valves, valve 20 does not need to be propped open, e.g., with a rod or straw, in order to allow fluid to egress from the container.

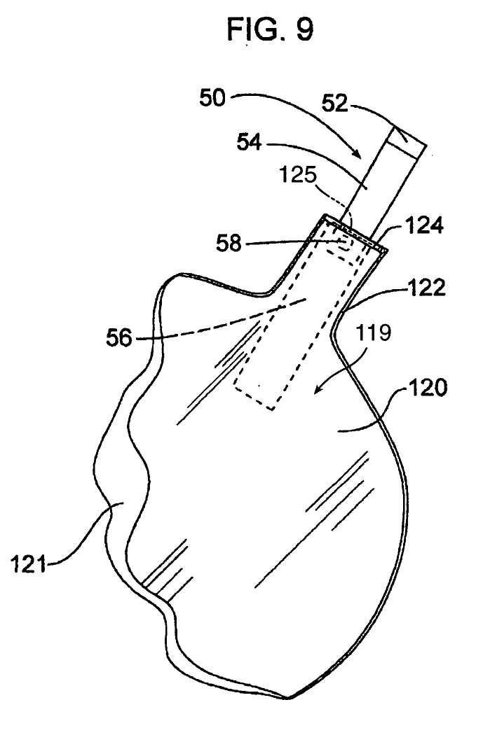

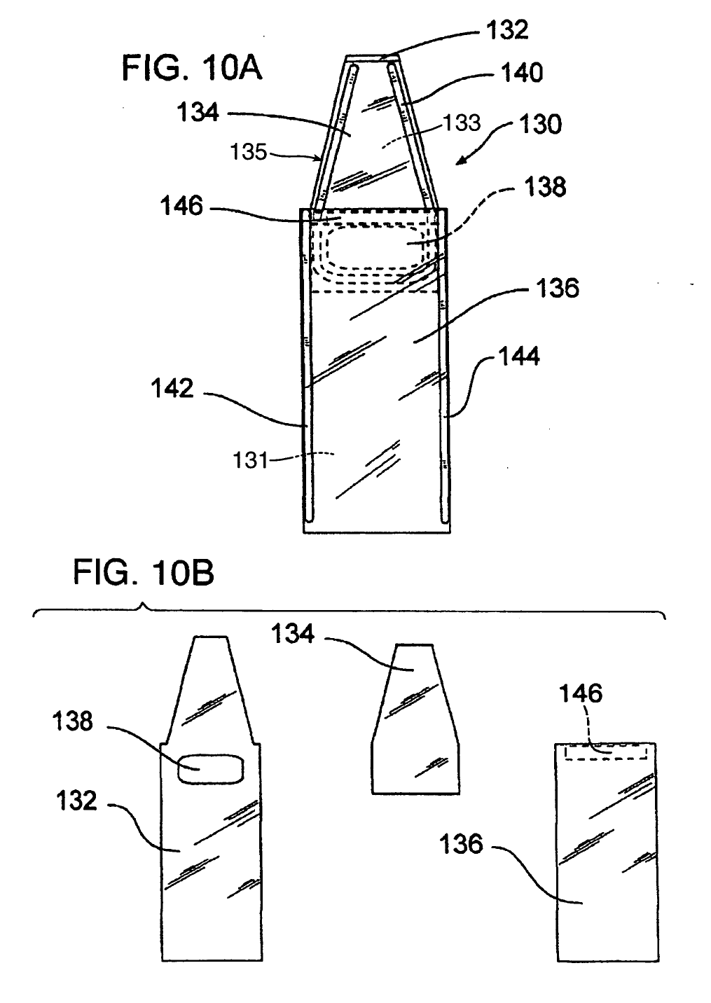

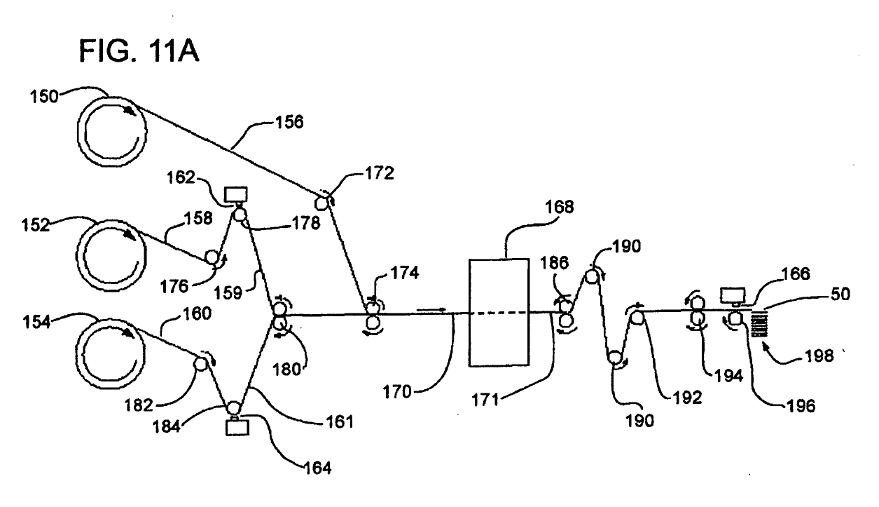

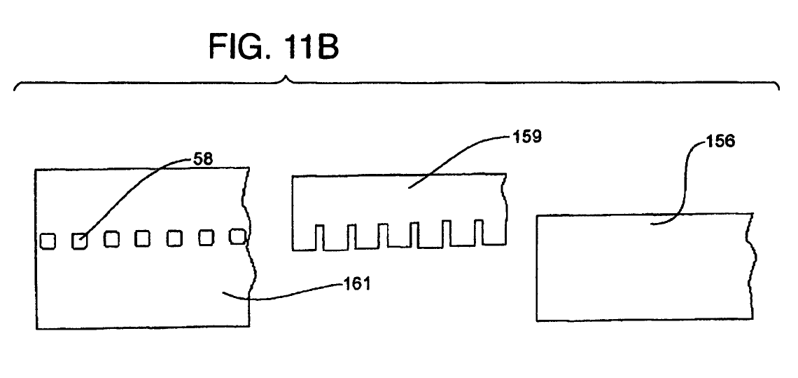

FIGS. 5-6 illustrate another aspect of the present invention, namely, flexible valve 50, which comprises two or more juxtaposed film plies 52, 54, 56 that are joined together with one or more seals 60, 62, and 64. Like valve 20, valve 50 is movable between:

a. an ingress position (FIG. 6A) to allow fluid flow through the valve in a first direction 53a;

b. a seal position (FIG. 6C) to substantially prevent fluid flow through the valve; and

c. an egress position (FIG. 6D) to allow fluid flow through the valve in a second direction 53b.

Similar to valve 20, flexible valve 50 may include a body 57 and a neck 59 affixed to the body, with neck 59 being movable relative to body 57 to effect the seal and egress positions.

When valve 50 is in the egress position (FIG. 6D), neck 59 is extended outwardly from body 57. In contrast, when valve 50 is in the ingress (FIG. 6A) or seal (FIG. 6C) positions, neck 59 is at least partially contained within body 57, e.g., by being folded such that at least a segment thereof is contained within the body as shown.

As also shown, body 57 may include a body channel 51; for reasons which will become apparent, for the embodiment represented by valve 50, the “body channel” 51 will be referred to as the “ingress channel” 51. Similarly, neck 59 may include a neck channel 55, but also for reasons that will become apparent, such “neck channel” will hereafter be referred to as the “egress channel” 55.

Valve 50 may be assembled in a nearly identical manner as that described above for valve 20 (depicted in FIG. 4A, 4B, and 4C). Thermoplastic film ply 52 is the bottommost valve layer as pictured in FIG. 5, and includes a hole 58. A thermoplastic film ply 54 is joined to film ply 52 through weld 60. A third thermoplastic film ply 56 contains a heat resistant coating 66 on its underside, and this film ply 56 is joined to the top of film ply 52 with two parallel heat seal welds 62 and 64. Alternatively or additionally, coating 66 may be applied to the upper side of film ply 54.

The primary differences between the valve 50 and the valve 20 formerly discussed are two-fold. First, valve 50 is partly assembled with two parallel weld lines 62 and 64 that define an open conduit, i.e., ingress channel 51, whereas valve 20 is partly assembled with a single U-shaped weld 32 that defines body channel 25 as a closed conduit or “pocket”. Secondly, the lower section of valve 50 (the section joined by welds 62 and 64) is preferably longer than the lower section of valve 20 (the section joined by weld 32). This additional length, which is highlighted by the bracket 61 in FIG. 5, allows ingress channel 51 to function as a ‘one-way’conduit, i.e., by allowing fluid flow in first direction 53a but substantially preventing fluid flow in the opposite direction, e.g., second direction 53b.

Thus, as shown in FIG. 6A, ingress channel 51 allows fluid flow in first direction 53a when fluid is introduced into such channel, e.g., via a fluid injection device 42. When valve 50 is affixed as shown in FIG. 6A to a container 63, fluid flow in first direction 53a is generally from a fluid source outside of the container, through ingress channel 51, and into the container; hence the term “ingress channel.” However, because of the extra length 61 of ingress channel 51, it substantially prevents fluid flow in the opposing direction, e.g., second direction 53b.

As also shown in FIG. 6A, valve 50 is in fluid communication with, e.g., incorporated into, a container 63, with fluid 53a being introduced through the valve and into the container by fluid injector 42. As with container 45 described above, container 63 may be formed from a container housing comprising a top film ply 38 and lower film ply 39, e.g., flexible thermoplastic film plies. A weld line 68 may join the film plies 38, 39, and also join film ply 38 to upper valve ply 56. An additional weld line 69 is applied to the underside of the article as pictured, joining container ply 39 to lower valve ply 52. In this manner, valve 50 may be hermetically sealed within container 63 such that the valve 50 provides the only access point through which fluids may be introduced into or expelled from the container (assuming no other valves or openings in the container).

Heat resistant coating 66 may be included to prevent undesired joining of upper film ply 56 to intermediate film ply 54 during the application of weld 68, in order to maintain an opening 65 between the two film plies (FIGS. 5, 6B). Opening 65 allows access to ingress channel 51.

Valve 50 may include four (4) distinct orifices as follows. As with valve 20, a first orifice 67 may be located at a distal region 70 of neck 59 such that the orifice 67 is in fluid communication with egress channel 55. As shown, first orifice 67 may be formed by an unsealed gap between film plies 52 and 54. Similarly, valve 50 may further include a second orifice formed by hole 58 (henceforth termed “second orifice 58”), which may be located at a proximal region 71 of neck 59, and which is also in fluid communication with egress channel 55. As shown, the proximal region 71 of neck 59 is the general region of valve 50 at which the neck is affixed to body 57; the distal region 70 is the general region of neck 59 that extends outwardly from the proximal region 71.

Valve 50 may further include a third orifice 72 located at a distal region 73 of body 57, such that the orifice 72 is in fluid communication with ingress channel 51. As shown, third orifice 72 may be formed by an unsealed gap between film plies 52 and 56. Opening 65 may serve as a fourth orifice, located at proximal region 74 of body 57. Such opening/fourth orifice 65 may also be open to, e.g., allow fluid communication with, ingress channel 51, and may be adapted to receive a fluid injection device 42 when valve 50 is in the ingress position shown in FIG. 6A, to thereby cause fluid flow in first direction 53a. Accordingly, fluid flowing in first direction 53a may thus flow into valve 50 via fourth orifice 65, through ingress channel 51, and out of ingress channel 51/valve 50 via third orifice 72 when the valve is in the ingress position shown in FIG. 6A. The fluid 53a may then flow into the interior of the container 63 as shown, thereby filling such container to a desired extent.

As may also be gleaned from FIG. 6A, neck 59 may be at least partially contained within body 57 when valve 50 is in the ingress position such that it allows fluid flow in first direction 53a. As shown perhaps most clearly in FIG. 6B, this may be accomplished by folding the neck 59 and tucking the distal region 70 thereof into ingress channel 51 via opening/fourth orifice 65, much like neck 23 is inserted into body channel 25 via opening 37 when valve 20 is in the seal position (FIG. 3B). However, while body channel 25 is primarily intended only to accommodate neck 23 when valve 20 is in the seal position, ingress channel 51 of valve 50 serves the additional role of providing a conduit for fluid flow in first direction 53a into container 63. Thus, during the introduction of fluid 53a through valve 50, fluid injector 42 may be inserted between the folded neck 59 and upper valve ply 56 in the opening/fourth orifice 65. In this manner, no fluid flowing in first direction 53a passes through neck 59 or, more specifically, through the egress (neck) channel 55. Instead, the flowing fluid 53a actually passes over top of the folded neck 59, and then continues to flow through the remainder of the ingress channel 51 before entering the interior of container 63 (FIG. 6A).

When a desired amount of fluid has been introduced into container 63, the user stops fluid flow 53a into the container and removes the fluid injector 42. In the illustrated embodiment, once the fluid flow stops, valve 50 automatically seals closed such that container 63 will maintain fluid therein, e.g., remain inflated if the fluid 53a is gas, without further action on the part of the user. That is, if body 57 is made sufficiently long, the elevated pressure within the filled container 63 pushes together the valve film plies 52, 56, from which the body 57 is constructed, thereby preventing any fluid outflow through ingress channel 51. As noted above, this may be accomplished by constructing body 57 with an extended section 61 in distal region 73 (FIG. 5), wherein valve plies 52, 56 may be forced flush against each other by the internal pressure within container 63 (once fluid flow 53a stops). The necessary length for extended section 61 may be readily determined by one of ordinary skill in the art with simple empirical observation. For example, if it is observed that the folded neck 59 keeps ingress channel 51 propped open, section 61 is likely too short and needs to be extended further in order to substantially prevent fluid flow in the reverse direction, e.g., second direction 53b , through ingress channel 51.

For the reasons explained above in connection with FIG. 3B, the same internal pressure in container 63 that acts on ingress channel 51 will also prevent any flow through the egress channel 55 in neck 59 when the neck is folded into ingress channel 51. As may thus be appreciated, neck 59 may be folded into ingress channel 51 both when valve 50 is in the ingress position (FIG. 6A) and in the seal position (FIG. 6C). Fluid can therefore be made to flow through ingress channel 51 via fourth orifice/opening 65 when valve 50 is already in the seal position, i.e., with (1) neck 59 folded and (2) injection device 42 inserted into the fourth orifice. In this manner, upon removal of the fluid injection device 42 from fourth orifice 65, valve 50 will automatically be in the seal position shown in FIG. 6C to maintain fluid within container 63.

Valve 50 may be configured such that ingress channel 51 and egress channel 55 are not in direct fluid communication with one another. Thus, while ingress channel 51 allows fluid flow in only one direction 53a , i.e., into the container, such fluid does not simultaneously and undesirably flow out of the container through egress channel 55 when neck 59 is folded into fourth orifice 65. However, when it is desired to expel the fluid from container 63, neck 59 may be unfolded so that valve 50 assumes the egress position shown in FIG. 6D. This permits fluid flow in direction 53b through egress channel 55 and out of container 63 as shown, but substantially no fluid flows through ingress channel 51 during this process.

As may be appreciated, during egress flow, neck 59 of valve 50 operates in a manner that is quite similar to the operation of neck 23 of valve 20. However, while channel 27 of neck 23 provides both ingress and egress flow in the embodiment of valve 20, channel 55 in neck 59 of valve 50 functions only for egress flow out of container 63. Hence, the term “egress channel,” instead of “neck channel,” is used to describe channel 55 in neck 59 of valve 50.

In comparing FIGS. 6C with 6D, it may be seen that neck 59/egress channel 55 is movable between:

(1) a seal position to substantially prevent fluid flow through egress channel 55 (FIG. 6C), and

(2) an egress position to allow fluid flow through egress channel 55 (FIG. 6D).

Similar to valve 20, when egress channel 55 of valve 50 is the egress position as shown in FIG. 6D, fluid inside container 63 can flow into egress channel 55 via second orifice 58 and exit the egress channel and valve through first orifice 67. Also like valve 20, when egress channel 55 is in the egress position, it is capable of maintaining itself in an opened configuration to allow fluid flow in second direction 53b without the need for external manipulation of the channel. In this manner, valve 50 can release fluid from container 63 without the necessity of being propped open, e.g., with an external object such as a rod or straw, as is typically required of conventional valves.

Instead, all that the user must do to initiate sustained expulsion of fluid from container 63 is to remove neck 59 from fourth orifice/opening 65 in the ingress channel 51. When the neck is thereby removed, it is no longer subjected to the sealing pressures within the filled container. Fluid will consequently flow from the relatively pressurized interior of the container 63, through second orifice 58, through the egress channel 55, and into the outer surroundings via first orifice 67. This fluid flow is indicated by the arrows 53b in FIG. 6D.

Accordingly, as may be appreciated by the foregoing, valve 50 may be described as a flexible, lay-flat, two-way, self-sealing, and self-expelling valve, in which separate ingress and egress channels provide dual functionality.

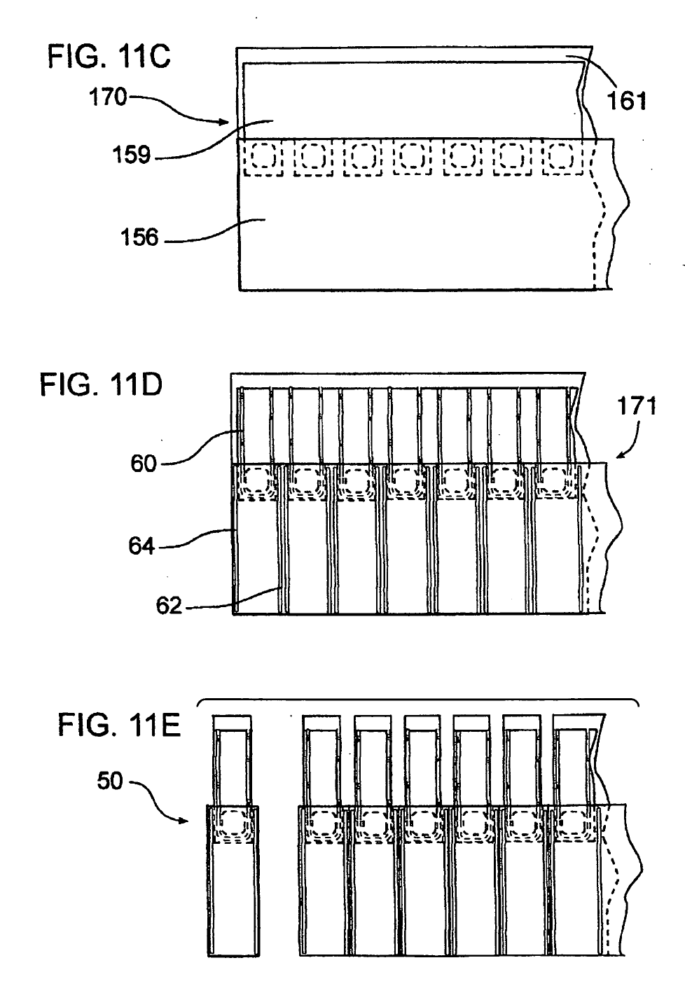

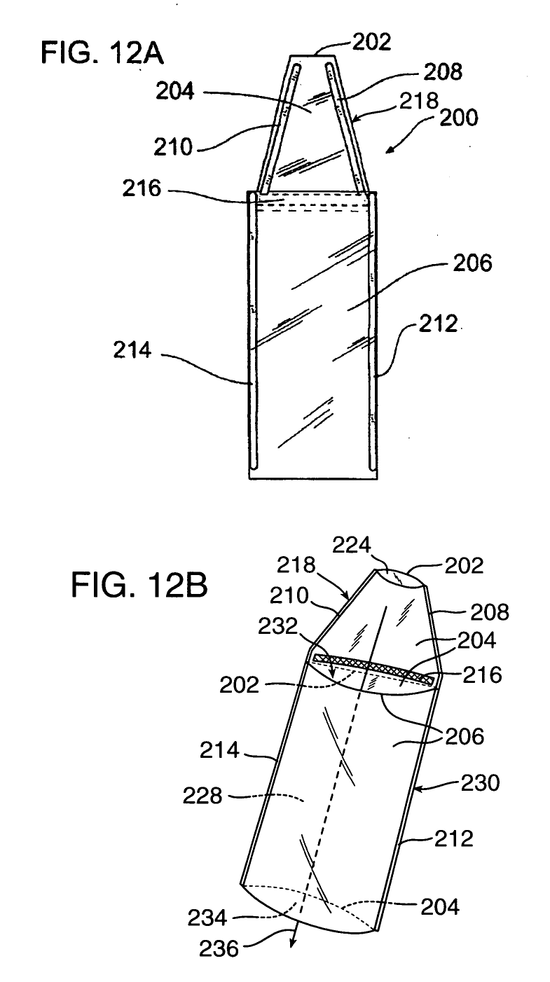

Referring now to FIGS. 7A and 7B, a further embodiment of the present invention will be described. The assembly of this valve structure, designated generally by the reference 80, is nearly identical in basic form to that of the previously-described valve structures. A thermoplastic sheet or film ply 82 of particular shape, notably containing a hole 88 and shaped the same as the outline of the entire valve structure, is the bottommost layer of the structure as pictured. A second thermoplastic sheet 84 is joined to the top of sheet 82 with a U-shaped weld 90 (the terms “sheet” and “film ply” are used interchangeably herein). The third and final layer of the structure is a thermoplastic sheet 86, which is joined to sheet 82 with a weld 92. The underside of sheet 86 is imprinted with a heat resistant coating 94, to prevent undesired joining of valve structure components during incorporation into a container by heat sealing methods.

FIG. 7B depicts such an incorporation of the valve 80 into an inflatable or liquid-containing container 81. Container 81 may be the same as that described above, namely comprising two thermoplastic sheets 38 and 39. Also, the heat sealed welds 96 and 97 may be applied in the same manner as that employed in the above-described embodiments. More specifically, weld 96 joins sheet 38 and 39, and also joins sheet 38 to valve component 86; and weld 97 joins sheet 39 and valve component 82. The only difference of note between the incorporation of valve 80 into a container and that of the above-described valves is the application of a third weld 98. Weld 98 joins sheet 38 to valve component 86 along a different area than that covered by weld 96. The significance of this additional weld 98 will become apparent in the operation description of valve 80 as follows.

The valve structure 80 operates in much the same manner as the valve structure 20, as discussed above. The U-shaped weld 90 defines a neck channel 83 in the neck 85 of the valve structure, whereas a larger U-shaped weld 92 defines a pocket-type body channel 87 in body 89. This channel 87, as with valves 20 and 50, allows valve closure by folding neck 85 therein, so that internal pressure within container 81 can seal the neck closed. The difference between valve 80 and that of valve 20 relates to the opening 91 into channel 87 (i.e., the “fourth orifice”), which is defined by weld 92 (FIG. 7A). As shown, the opening 91 is funnel or collar-shaped, rather than rectangular as in the previously described valves. This particular structure of valve 80, with collar, has the advantage of enabling the user to more easily fold the valve neck 85 into the body channel 87 when sealing the valve and container 81. Also of note is the additional weld 98; this weld may be necessary to prevent the body 89 from being pushed out of the interior of container 81 following fluid-filling and periods of increased pressure (as when the filled container is squeezed).

As was the case with valve structure 20, in order to seal valve structure 80, the user may fold the valve neck 85 into body channel 87. If desired, the pocket-shaped body channel 87 of valve 80 may be lengthened as at 61 in FIG. 5 (by approximately twice its pictured length or more), and the horizontal bottom of the U-shaped weld 92 may be omitted to transform the “pocket” into an open valve channel, similar to ingress channel 51 in valve 50. With this alteration, valve 80 becomes a self-sealing valve with a separate release mechanism (i.e., via the neck 85). Further, because the body section 89 is funnel or collar-shaped, liquid can easily be poured into (and automatically sealed within) the container 81 through the body channel 87. And, just as any fluid can be released through the valve neck 85 when it is removed from the body channel 87, the liquid introduced into container 81 can subsequently be poured from the container via neck 85.

Although the neck 85 is shown centered in the funnel-shaped collar/opening into body channel 87, it need not be so. Indeed, the collar can be widened and offset. Such a valve, when incorporated into an appropriate container, would facilitate liquid filling of such a container as the collar would function as a large funnel directing liquid through the body channel and into the container.

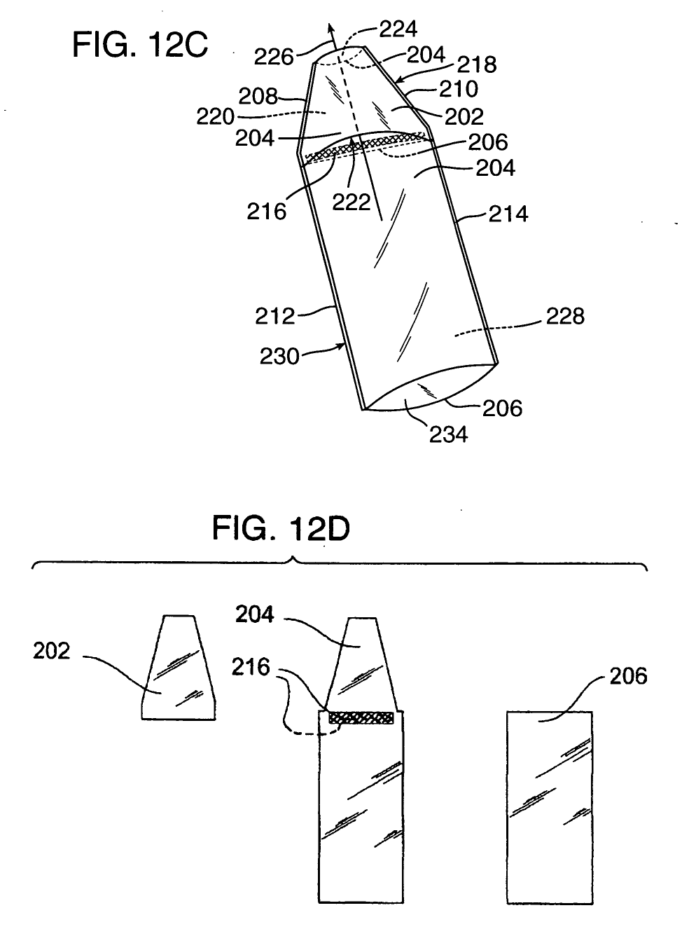

FIG. 8 depicts another embodiment of a valve 100 in accordance with the present invention. In this case, the self-sealing structure of valve 50 has been altered to produce a body 101 having a split ingress channel 103, with a pair of exit orifices 105a, b (as opposed to the single exit orifice 72 of body 57 in valve 50). The steps required to assemble valve 100 are rather similar to those employed for valve 50. A thermoplastic sheet 102, the shape of which can be discerned by taking the entire outline of the structure pictured in FIG. 8, with hole 108 is the bottommost layer as pictured. A thermoplastic sheet 104 is joined to sheet 102 with U-shaped weld 110; the weld 110 defines an egress channel 107 between sheets 102 and 104 in the neck 109 of the valve structure. A third thermoplastic sheet 106 is joined to sheet 102 with three welds 112, 114, and 116. These welds define ingress channel 103, which diverges into two separate channels that terminate in respective exit orifices 105a, b. As before, a heat resistant coating 118 may be included between sheets 104 and 106, on the facing surface(s) of either or both sheets, to prevent undesired bonding of such sheets in this area during the heat-welding of valve 100 to a container.

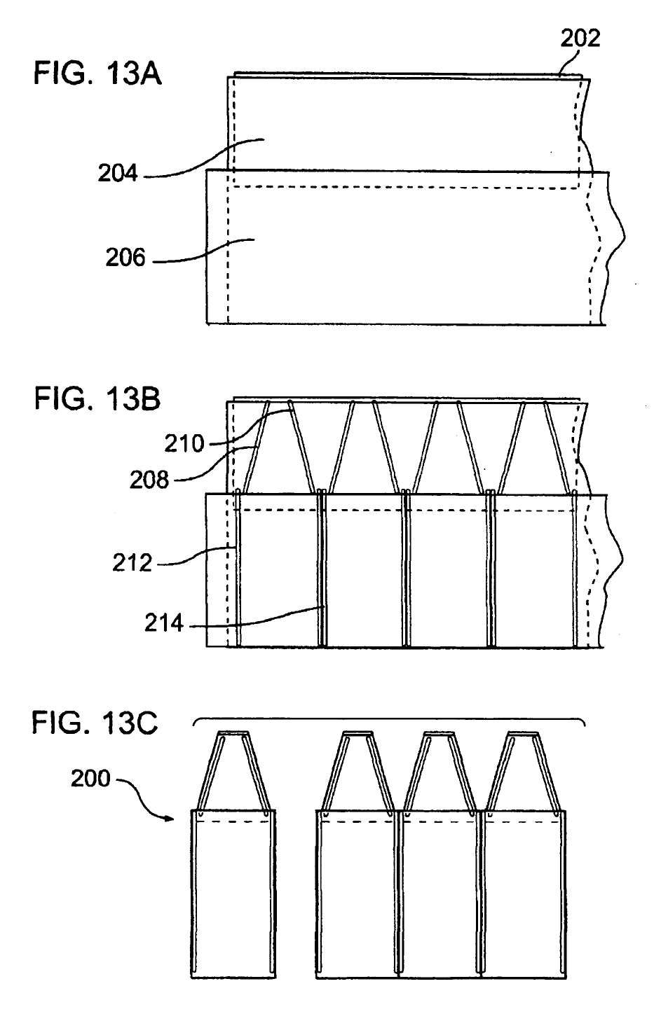

FIG. 9 simply depicts the incorporation of valve structure 50 into an inflatable article 119 with a tapered neck, such as is often the case with certain types of novelty balloons. The article comprises two thermoplastic sheets 120 and 121 superimposed on one another. The valve structure 50 is placed between the sheets 120 and 121. A heat sealing weld 122 is applied around the perimeter of the article, joining the edges of sheets 120 and 121. Two additional welds 124 and 125 applied to the end of the tapered neck join sheet 120 to valve component 56, and sheet 121 to valve component 52, respectively. The welds 122 and 124 can be made simultaneously with heat sealing or adhesive application techniques well known in the art. The operation of this valve 50 in the balloon-shaped article with tapered neck is nearly identical to that employed with the valve 50 in any type of article.

FIG. 10A depicts yet another alternate embodiment of a self-sealing valve structure with a self-maintaining egress mechanism in accordance with the present invention. This valve structure, designated generally by the reference 130, may be nearly identical in basic form to that of the valves in accordance with the present invention described hereinabove. A thermoplastic sheet 132 of particular shape, notably containing a hole 138, is the bottommost layer of the structure as pictured. A second thermoplastic sheet 134 is joined to the top of sheet 132 with an open ‘pear-shaped’weld 140. The third and final layer of the structure is a thermoplastic sheet 136, which is joined to sheet 132 with parallel welds 142 and 144. The underside of sheet 136, and/or the upper side of sheet 134, may be imprinted with a heat resistant coating 146, to prevent undesired joining of valve structure components during incorporation into an article by heat sealing methods. For clarity, the three valve sheet components 132, 134, and 136 are illustrated separately in FIG. 10B.

The operation of this valve structure 130 is very similar to that of valve 50, discussed previously at length. However, this particular valve 130 may be particularly advantageous when the end-use objective is the containment of a liquid within an article such as a water bag. As with valve 50, valve 130 will enable liquid to be sealed within such a container automatically when poured through the ingress channel 131 defined by welds 142 and 144. In addition, the liquid may be dispensed easily through the egress channel 133 at the user's discretion. Such dispensation may be facilitated by the shape of neck 135, which is a tapered shape. This enables a more easily controlled pouring of liquid from the article. Additionally, hole 138 in bottom-most sheet 132 may be substantially larger than the corresponding holes of previously discussed valve structures. The larger hole 138 allows for greater flow rates than is possible through the smaller holes of the other embodiments, conferring yet greater usefulness to the valve structure 130 when the containment and dispensation of liquids is an objective.

Referring now to FIG. 11A, a method for the continuous manufacture of flat, flexible valves comprising three film sheets will be described. For ease of illustration, the following description will be based on the assembly of valve 50. It should be recognized, however, that the manufacturing method depicted is more general in nature, and can be employed in the manufacture of a wide variety of flat valves of three or more layered components, such as those described hereinabove. Webs of film 156, 158, and 160 are continuously fed from unwind mandrils 150, 152, and 154, respectively. Each web of film is of varying width, corresponding to the width of the final valve component into which it will be converted downstream of the mandrils. Note that the term “continuously” in these contexts includes the sense of rolls or spools of material fed to a production line in a step-wise or indexed fashion to account for step-type unit operations (such as die cutting) that may occur within a production line.

The web 158 continues from the mandril 152, beneath a guide roll 176, and through a punch assembly consisting of an anvil roller 178 and cutting blades 162. The punch assembly cuts a progression of appropriate holes and shapes into the web 158, with the resulting altered film being referred to as film 159. A section of the resultant film 159 is depicted in FIG. 11B. Web of film 160 undergoes a similar process, as it is fed over guide roll 182 and through a punch assembly consisting of an anvil roller 184 and cutting blades 164. This punch assembly cuts a progression of appropriate holes and shapes into web 160, with the resulting altered film being referred to as film 161. A section of the resultant film 161 is depicted in FIG. 11B; of note, the hole 58 corresponds to the same hole 58 in the valve structure 50 first depicted in FIG. 5.

The two newly cut webs of film 159 and 161 are preferably made such that they maintain enough structure, despite the initial cutting process, so as to be reliably pulled throughout the assembly process as continuous lengths of film. In addition, the films coming off of the unwind mandrils may be made of varying widths, as mentioned, before they enter the corresponding punch assemblies, so as to minimize plastic waste resulting from the cutting step.

The films 159 and 161 are united at feed rollers 180. After passing over guide roller 172, film 156 from the topmost mandril 150 is united with the films 159 and 161 at a second set of feed rollers 174. A resulting web of film 170, consisting of three layers of film, then travels into a sealing module 168. Because the following description is made with reference to the assembly of valve structure 50, the reader should note that film 156 corresponds to valve component 56; film 159 corresponds to valve component 54; and film 161 corresponds to valve component 52 (FIG. 5). A sectional view of the layered web 170 before it enters the sealing module is shown in FIG. 11C.

The sealing module 168 may employ any of a number of known means to bond the three layers of film together along the zones indicated by welds 60, 62, and 64 (FIG. 5). For example, known heat sealing techniques (e.g., conductance, impulse, ultrasonic, dielectric, or RF sealing) may be utilized to expose the film web 170 to heat and pressure for a sufficient dwell time to seal the films together. If heat sealing is the technique employed, note that heat is preferably applied to the bottom of the web 170 as pictured, since in this way the weld 60 (FIG. 5) may avoid accidentally joining film 159 to film 156. As discussed above, appropriately-placed heat-resistant coatings may also be employed to prevent undesired joining of film components.

An alternative to heat sealing is the application of suitable adhesive to selected areas of the three films upstream from the sealing module 168—such as immediately following the films'departure from their respective unwind mandrils. Sealing module 168 can then expose the united web 170 to the appropriate curing agent, whether it be hot air or UV light or any of a number of established techniques in the art. In such a manner, the films comprising web 170 may be joined together along appropriate zones, with a web of film 171 resulting. This web 171, with appropriate welds, is depicted in FIG. 11D.

Web 171 is effectively a plurality of parallel, connected valve structures, in this particular case a plurality of valve structure 50. This web 171 may travel through a set of feed rollers 186, through an inventory roller assembly 190, and around a guide roller 192. As is known in the art, an inventory roller assembly includes a plurality of rollers that are moveable in the vertical direction relative to each other and serve to regulate the web inventory so that various modules within the production line may operate at varying speeds relative to each other. While a single inventory roller assembly has been included in this particular manufacturing operation for simplicity, additional inventory roller assemblies may be included further upstream of the production line, particularly preceding cutting and joining operations.

Web 171 may then be fed through a motor-driven set of feed rollers 194, and finally into a punch assembly comprising an anvil roller 196 and cutting blades 166. This punch assembly cuts the web 171 along the overall outline of the entire valve structure 50, in this particular case. The result of this final step is a plurality of completely defined valves of the structure of valve 50, which may be stacked into valve stack 198 for later incorporation into appropriate articles. The result of this final operation is depicted in FIG. 11E. Also note that while in this particular embodiment the valves have been cut and stacked, the last cutting operation can be eliminated. Instead, the web 171 may be fed onto a rewind mandril, forming a roll that may later be cut at a separate facility into the individual valves.

From the preceding manufacturing operation description, it should be clear that the act of cutting the appropriate webs of film (as illustrated in FIG. 11B for film 161 and 159) before joining into web 170 enables a single sealing step followed by a single perimeter cutting step to completely assemble a plurality of valves with release mechanisms. This “precutting” step, which transforms the web 158 into film 159, and likewise transforms web 160 into film 161, also enables a multi-layered flat valve (with three or more layered components) to be assembled in a continuous fashion, with all component parts simply being sections of continuous webs of film.

As a final note, appropriate zones of heat resistant coating can be applied to the various webs of film. This is preferably done before the webs are united, and can be easily added immediately following the unwinding of the webs of film from their mandrils. The incorporation of the assembled valve structures into appropriate inflatable and liquid containing articles can be accomplished through methods well known to those skilled in the art, and so will not be reiterated here.

FIGS. 12A-D depict a further embodiment of the invention. This valve, designated generally by the reference 200, employs an alternative second orifice for the egress channel. A thermoplastic sheet 202 is the bottommost layer of the structure as pictured. A second thermoplastic sheet 204 is joined to the top of sheet 202 with two or more welds 208 and 210. A third layer of the structure is a thermoplastic sheet 206, which is joined to sheet 204 with approximately parallel welds 212 and 214. In order to prevent the unintended welding of components during incorporation of the valve into a container, both sides of sheet 204 may be imprinted with heat resistant coating 216. For clarity, the three valve sheet components 202, 204, and 206 are illustrated separately in FIG. 12D.

The operation of this valve structure 200 is almost identical to that of valve 130, discussed previously, except for the operation of the egress channel. Neck 218 includes egress channel 220 therein (FIG. 12C). Egress channel 220 is defined by the space between sheets 202 and 204. During expulsion of a fluid from a container with which valve 200 is associated, fluid will flow into second orifice 222, through egress channel 220, and out of valve 200 (and out of the container) via first orifice 224, as indicated by arrow 226 in FIG. 12C. In this embodiment, second orifice 222 is defined by the gap between the non-sealed lower edge of sheet 202 and the planar surface of adjacent valve sheet 204. In contrast, the second orifice 58 of valve 50, as well as the “second orifice” 138 of valve 130, is disposed within a generally planar surface of the neck of such valves, i.e., within sheet 52 of valve 50 and within sheet 132 of valve 130, e.g., via holes cut into such sheets. Fluid flow direction 226 is thus similar to “second direction” fluid flow direction 53b out of valve 50 (FIG. 6D).

As with valves 50 and 130, valve 200 also includes an ingress channel 228 in valve body 230 (FIG. 12B). Fluid flowing into a container via valve 200 may thus flow into fourth orifice 232, through ingress channel 228, and out of valve 200 (and into the container) via third orifice 234, as indicated by arrow 236 in FIG. 12B. As is also the case with valves 50, 130, neck 218 of valve 200 may be folded into ingress channel 228 (via fourth orifice 232) during the container-filling operation, thereby ‘pre-sealing’the egress channel 220. In this manner, upon removal of a fluid injection device from fourth orifice 232, valve 200 and the container with which it is associated will be automatically sealed (assuming that ingress channel 228 is also constructed to be self-sealing as described above).

The embodiment depicted in FIGS. 12A-D may be manufactured by overlapping three films of various widths, then performing a single heat welding operation, followed by a single die cutting operation. These manufacturing steps are depicted in FIGS. 13A, 13B, and 13C. Note that the heat resistant coating 216 typically applied to this embodiment is not depicted for clarity of illustration. FIG. 13A depicts the overlapping of the three thermoplastic sheets 202, 204, and 206. FIG. 13B depicts the heat welding operation, which may be accomplished with a single welding pattern applied from a single side of said overlapped sheets. FIG. 13C depicts the die cutting operation, whereby individual valve assemblies are cut from the welded continuous sheet assembly. Note that in order to reduce thermoplastic cuttings waste, an additional row of valves, oriented at 180 degrees rotation to the pictured row of valves, may be incorporated into a manufacturing process.

Accordingly, the flexible valves of the present invention provide several advantages over conventional flexible valves. In preferred embodiments of the invention, the valve includes an egress/neck channel that is capable of maintaining itself in an opened configuration to allow fluid flow out of a container without the need for external manipulation or support of the channel. As such, the user is no longer forced to employ the clumsy and potentially damaging fluid-release techniques of the prior art, such as the insertion of foreign objects (such as rods and straws and the like) into the valve channel to allow for fluid release. Instead, the incorporated valve release mechanism in accordance with the present invention can be easily deployed by the user by simply pulling the valve neck out of the valve body, thus initiating fluid release without any need of foreign objects and without potentially damaging the valve interior through contact with such foreign objects.

Moreover, flexible valves in accordance with the present invention can be entirely constructed of thermoplastic films such that the valves are substantially completely flat when not in use, i.e., when no fluid flows through the valve. Further, the valves can be made entirely from a single type of material, e.g., a heat-sealable, thermoplastic film, a heat-resistant film with adhesive, or any of a number of other possibilities, which simplifies the manufacture of such valves.

The valves of the present invention have a wide array of end-use applications in fields ranging from industrial packaging to novelty toys. For instance, a flat, flexible valve with an incorporated egress mechanism (movable neck) can add great speed to the deflation phase of large bracing dunnage bags, such as those used in cargo bays. Similarly, smaller retail dunnage bags for small scale packaging applications can benefit from a valve with a self-supporting egress mechanism as well; easy deflation of the bags on the consumer side can aid in both bag disposal and also bag reuse. Easy consumer-side deflation makes possible a closed loop packaging chain, in which the consumer, upon receipt of package and inflated dunnage bag, may easily deflate the bag and send it back to the distributor in a self-addressed paid-postage envelope for reuse. In such a closed loop arrangement, the distributor benefits from lower packaging costs, and the environment benefits from essentially zero packaging dunnage waste.

A similar approach can be employed with inflatable packaging articles of all kinds; for instance, “clamshell” air-filled packaging envelopes such as those described by Pharo in U.S. Pat. No. 5,588,532 (1996) could benefit from the present valve with egress mechanism and the associated closed loop, “no waste” packaging chain. All such devices presently utilizing conventional flat valves can incorporate the inventive flat valve with egress mechanism and achieve all of the advantages that derive from the present invention.

The valves of the present invention are not limited to packaging; virtually any application in which conventional flexible valves are used can instead employ the flexible valves of the present invention. Some examples include balloons, floatation devices (e.g., rafts), inflatable toys, etc.

Some embodiments of the inventive flexible valve can be incorporated into liquid containers, e.g., water-tight bags or rigid containers, thus yielding an inexpensive self-sealing article with built-in pour spout (i.e., the movable neck/egress channel). Conventional flexible valves generally cannot accomplish containment and subsequent user-initiated fluid release of water or other liquids. The flexible valves of the present invention make the manufacture of functional liquid-containing articles constructed entirely of plastic films possible. Not only do such articles have applications in industrial packaging, but a self-sealing, liquid containing bag with an easy and controllable egress mechanism has applications in other fields, e.g., solar water disinfection for emergency and other uses.

The overall size of the valve described herein may vary depending upon the application. Similarly, the relative sizes of the components of the valve are also variable to a certain extent, with functionality maintained in many instances. For example, the width of the valve neck can be decreased and valve functionality will, in general, be maintained.

While the valves of the present invention seal reliably in many applications, the manufacturer may wish to enhance the functionality of the valves when considering containment of lighter-than-air gases such as helium. Many techniques are known in the art to accomplish this enhancement, such as the application of a small amount of coating, e.g., silicone, to the interior of the ingress channel. Additionally, a small amount of a releasable/re-sealable adhesive substance, e.g., glycerin, mineral oil, repositionable (non-permanent/tacky) adhesive, applied in a similar fashion may serve the same purpose of increasing the sealability of the valve channel.

Accordingly, the flexible valves of the present invention have applications for both gas and liquid containment. Also, the valves need not be restricted to applications involving flat flexible containers, such as bags and balloons. Indeed, rigid containers, too, could benefit from the usefulness and cost-effectiveness the valves presented herein.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A flexible valve, comprising two or more juxtaposed film plies joined together with one or more seals, wherein said valve is movable between:
a. an ingress position to allow fluid flow through said valve in a first direction;
b. a seal position to substantially prevent fluid flow through said valve; and
c. an egress position to allow fluid flow through said valve in a second direction,
wherein, when said valve is in said egress position, said valve is capable of maintaining itself in an opened configuration to allow fluid flow in said second direction without the need for external manipulation of said valve.

2. The flexible valve of claim 1, wherein said valve comprises a body and a neck affixed to said body, said neck being movable relative to said body.

3. The flexible valve of claim 2, wherein said neck is at least partially contained within said body when said valve is in said seal position.

4. The flexible valve of claim 2, wherein
said body includes a body channel; and
said neck includes a neck channel.

5. The flexible valve of claim 4, wherein said body channel and said neck channel are not in direct fluid communication with one another.

6. The flexible valve of claim 4, wherein:
said valve further includes at least a first orifice located at a distal region of said neck; and
said first orifice is in fluid communication with said neck channel.

7. The flexible valve of claim 6, wherein said first orifice is adapted to receive a fluid injection device when said valve is in said ingress position.

8. The flexible valve of claim 6, wherein fluid flowing in said second direction flows through said neck channel and exits said valve through said first orifice when said valve is in said egress position.

9. The flexible valve of claim 6, wherein:
said valve further includes a second orifice located at a proximal region of said neck; and
said second orifice is in fluid communication with said neck channel.

10. The flexible valve of claim 9, wherein fluid flowing in said first direction flows into said valve via said first orifice, through said neck channel, and out of said valve via said second orifice when said valve is in said ingress position.

11. The flexible valve of claim 9, wherein fluid flowing in said second direction flows into said valve via said second orifice, through said neck channel, and out of said valve via said first orifice when said valve is in said egress position.

12. The flexible valve of claim 9, wherein:
said valve further includes a third orifice located at a distal region of said body; and
said third orifice is in fluid communication with said body channel.

13. The flexible valve of claim 12, wherein fluid flowing in said first direction flows through said body channel and exits said valve through said third orifice when said valve is in said ingress position.

14. The flexible valve of claim 13, wherein said body channel is adapted to substantially prevent fluid flow in said second direction.

15. A flexible valve, comprising two or more juxtaposed film plies joined together with one or more seals, said valve comprising:
a. an ingress channel, which allows fluid flow in a first direction through said ingress channel but substantially prevents fluid flow in a second direction through said ingress channel; and
b. an egress channel, which is movable between:
(1) a seal position to substantially prevent fluid flow through said egress channel, and
(2) an egress position to allow fluid flow through said egress channel.

16. The flexible valve of claim 15, wherein, when said egress channel is in said egress position, said egress channel is capable of maintaining itself in an opened configuration to allow fluid flow without the need for external manipulation of said channel.

17. The flexible valve of claim 15, wherein
said valve comprises a body and a neck affixed to said body;
said body includes said ingress channel;
said neck includes said egress channel; and
said neck is movable relative to said body to effect said seal and egress positions.

18. The flexible valve of claim 17, wherein said neck is at least partially contained within said body when said egress channel is in said seal position.

19. The flexible valve of claim 17, wherein said neck is at least partially contained within said body when fluid flows through said ingress channel in said first direction.

20. The flexible valve of claim 15, wherein said ingress channel and said egress channel are not in direct fluid communication with one another.

21. The flexible valve of claim 17, wherein:
said valve further includes at least a first orifice located at a distal region of said neck; and
said first orifice is in fluid communication with said egress channel.

22. The flexible valve of claim 21, wherein, when said egress channel is in said egress position, fluid can flow through said egress channel and exit said valve through said first orifice.

23. The flexible valve of claim 22, wherein:
said valve further includes a second orifice located at a proximal region of said neck; and
said second orifice is in fluid communication with said egress channel.

24. The flexible valve of claim 23, wherein, when said egress channel is in said egress position, fluid can flow into said egress channel via said second orifice.

25. The flexible valve of claim 23, wherein:
said valve further includes a third orifice located at a distal region of said body; and
said third orifice is in fluid communication with said ingress channel.

26. The flexible valve of claim 25, wherein fluid flowing in said first direction flows through said ingress channel and exits said valve through said third orifice.

27. The flexible valve of claim 25, wherein:
said valve further includes a fourth orifice located at a proximal region of said body; and
said fourth orifice is in fluid communication with said ingress channel.

28. The flexible valve of claim 27, wherein, when said egress channel is in said seal position, fluid can flow into said ingress channel via said fourth orifice.

29. The flexible valve of claim 28, wherein said neck is folded into said fourth orifice when said egress channel is in said seal position.

30. The flexible valve of claim 27, wherein said fourth orifice is funnel-shaped.

31. A container, comprising a container housing and a flexible valve in fluid communication with said container housing, said flexible valve comprising two or more juxtaposed film plies joined together with one or more seals, wherein said valve is movable between:
a. an ingress position to allow fluid flow in a first direction through said valve and into said container housing;
b. a seal position to substantially prevent fluid flow through said valve; and
c. an egress position to allow fluid flow in a second direction through said valve and out of said container housing,
wherein, when said valve is in said egress position, said valve is capable of maintaining itself in an opened configuration to allow fluid flow in said second direction without the need for external manipulation of said valve.

32. A container, comprising a container housing and a flexible valve in fluid communication with said container housing, said flexible valve comprising two or more juxtaposed film plies joined together with one or more seals, said valve comprising:
a. an ingress channel, which allows fluid flow in a first direction through said ingress channel and into said container, but substantially prevents fluid flow in a second direction through said ingress channel; and
b. an egress channel, which is movable between:
(1) a seal position to substantially prevent fluid flow through said egress channel, and
(2) an egress position to allow fluid flow through said egress channel and out of said container.
